(19) United States
(12) Patent Application Publication
(10) Pub. No.: US 2026/0167029 A1
(43) Pub. Date: Jun. 18, 2026

(54) ALTERNATING CURRENT CHARGING OF A DIRECT CURRENT BATTERY PACK OF AN ELECTRIC VEHICLE USING FIELD-ORIENTED CONTROL

(71) Applicant: GM Global Technology Operations LLC, Detroit, MI (US)

(72) Inventors: Renato Amorim Torres, Pontiac, MI (US); Chandra S. Namuduri, Troy, MI (US); Lei Hao, Shelby Township, MI (US); Peng Peng, Rochester Hills, MI (US); Mohamed Ahmed Kamel Ahmed, Birmingham, MI (US)

(73) Assignee: GM Global Technology Operations LLC, Detroit, MI (US)

(21) Appl. No.: 18/986,194

(22) Filed: Dec. 18, 2024

(51) Int. Cl. B60L 53/24; B60L 15/02

(52) U.S. Cl. CPC B60L 53/24; B60L 15/025; B60L 2210/10; B60L 2210/30; B60L 2210/40; B60L 2240/423; B60L 2240/526

(57) ABSTRACT

A method includes coupling a charge port to an inverter and an alternating current (AC) electric motor. The method also includes performing field-oriented control (FOC) for controlling the inverter and the electric motor for converting AC power received from the charge port to first direct current (DC) power and charging a DC battery pack using the first DC power. Charging the DC battery pack using the first DC power may include converting, using a DC-to-DC converter, the first DC power to second DC power, and charging the DC battery pack using the second DC power.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

Field-oriented control (FOC), also known as vector control, is a method used to control the torque and speed of an electric motor, particularly in applications involving alternating current (AC) motors such as induction motors and permanent magnet synchronous motors (PMSMs). FOC is widely used in applications such as electric vehicles (EVs), robotics, and industrial automation due to its ability to provide smooth and efficient motor operation across a wide range of speeds and loads.

The present disclosure relates generally to AC charging of a DC battery pack of an electric vehicle (EV) using FOC.

### SUMMARY

One aspect of the disclosure provides a vehicle including an alternating current (AC) electric motor having a rotor, a battery pack, an inverter, a charge port, data processing hardware, and memory hardware. The battery pack is configured to provide first direct current (DC) power. The inverter is configured to convert the first DC power provided by the battery pack to first AC power for powering the electric motor. The charge port is configured to receive second AC power from an external AC power source. The memory hardware is in communication with the data processing hardware and stores instructions that, when executed by the data processing hardware, cause the data processing hardware to perform operations. The operations include selectively coupling the charge port to the inverter and the electric motor, performing field-oriented control (FOC) for controlling the inverter and the electric motor for converting the second AC power to second DC power, and charging the battery pack using the second DC power.

Implementations of the disclosure may include one or more of the following optional features. In some implementations, the vehicle also includes a DC-to-DC converter, wherein charging the battery pack using the second DC power includes converting, using the DC-to-DC converter, the second DC power to third DC power, and charging the battery pack using the third DC power. In some examples, performing FOC for controlling the inverter and the electric motor for converting the second AC power to the second DC power includes controlling a reference frame to be substantially aligned with a rotor position, controlling a d-axis current command to be sinusoidal, and controlling a q-axis current to be fixed. Additionally, or alternatively, performing FOC for controlling the inverter and the electric motor for converting the second AC power to the second DC power includes performing a resonant controller to regulate current at a pre-determined frequency. Additionally, or alternatively, performing FOC for controlling the inverter and the electric motor for converting the second AC power to the second DC power includes performing current control in an inner loop with an outer loop performing voltage or power control.

In some examples, performing FOC for controlling the inverter and the electric motor for converting the second AC power to the second DC power includes performing a phase lock loop configured to provide a stable grid voltage measurement, and using the stable grid voltage measurement as a reference for aligning grid current. In some implementations, the electric motor includes a permanent magnet motor, and the operations also include pre-aligning a motor position such that a d-axis of the rotor is aligned at 0 or 180 degrees with a phase of the electric motor to which the charge port is connected.

In some implementations, performing FOC for controlling the inverter and the electric motor for converting the second AC power to the second DC power includes performing a pulsating vector excitation (PVE) sensorless method that uses a voltage response on a q-axis of an estimated reference frame to allow aligning the d-axis of the estimated reference frame with the magnetic field d-axis of the rotor. Additionally, or alternatively, performing FOC for controlling the inverter and the electric motor for converting the second AC power to the second DC power includes performing initial rotor alignment using a gear lash or a clutch. Additionally, or alternatively, performing FOC for controlling the inverter and the electric motor for converting the second AC power to the second DC power includes adding small β-axis or q-axis current commands to generate a small average magnetic torque to reposition the rotor when rotor movement occurs. Additionally, or alternatively, performing FOC for controlling the inverter and the electric motor for converting the second AC power to the second DC power includes using an average reluctance torque to reposition the rotor when rotor movement occurs by injecting a small amount of AC current on a β-axis or a q-axis.

In some examples, performing FOC for controlling the inverter and the electric motor for converting the second AC power to the second DC power includes performing a rotor position controller includes at least one of a proportional-integral-derivative (PID) controller, a PID controller in series with an integrator, or a lead/lag compensator. Additionally, or alternatively, performing FOC for controlling the inverter and the electric motor for converting the second AC power to the second DC power includes performing current regulation using a rotating or stationary reference frame either using α-β signals or a-b-c signals. Additionally, or alternatively, performing FOC for controlling the inverter and the electric motor for converting the second AC power to the second DC power includes feeding forward of a grid voltage to regulate current. Additionally, or alternatively, performing FOC for controlling the inverter and the electric motor for converting the second AC power to the second DC power includes performing field winding current regulation to turn off a rotor magnetic field or adjust a rotor magnetic field level to achieve at least one of a desired machine inductance level, machine saliency, or grid voltage synchronization, that allows mitigation of torque. In some implementations, the operations also include reversing a direction of grid power flow between a grid-to-vehicle mode of operation and a vehicle-to-grid mode of operation.

Another aspect of the disclosure provides a system including an alternating current (AC) electric motor having a rotor, a battery pack configured to provide first direct current (DC) power, an inverter configured to convert the first DC power from the battery pack to first AC power for driving the electric motor, a charge port configured to receive second AC power from an AC power source, data processing hardware, and memory hardware in communication with the data processing hardware, the memory hardware storing instructions that, when executed by the data processing hardware, cause the data processing hardware to perform operations, The operations include selectively coupling the charge port to the inverter and the electric motor, performing field-oriented control (FOC) for controlling the inverter and the electric motor for converting the second AC power to second DC power, and charging the battery pack using the second DC power.

Implementations of the disclosure may include one or more of the following optional features. In some implementations, the system also includes a DC-to-DC converter, wherein charging the battery pack using the second DC power includes converting, using the DC-to-DC converter, the second DC power to third DC power, and charging the battery pack using the third DC power.

Another aspect of the disclosure provides a computer-implemented method executed by data processing hardware that causes the data processing hardware to perform operations. The operations include coupling a charge port to an inverter and an alternating current (AC) electric motor, performing field-oriented control (FOC) for controlling the inverter and the electric motor for converting AC power received from the charge port to first direct current (DC) power, and charging a DC battery pack using the first DC power.

Implementations of the disclosure may include one or more of the following optional features. In some implementations, charging the battery pack using the first DC power includes converting, using a DC-to-DC converter, the first DC power to second DC power, and charging the battery pack using the second DC power.

### BRIEF DESCRIPTION OF THE DRAWINGS

The drawings described herein are for illustrative purposes only of selected configurations and are not intended to limit the scope of the present disclosure.

FIG. 1 is a view of an example electric vehicle (EV) incorporating a charging system in accordance with the principles of the present disclosure.

FIG. 2 is a schematic view of the charging system of FIG. 1.

FIG. 3 is another schematic view of the charging system of FIG. 1.

FIG. 4 is a flowchart of another example arrangement of operations for a method of AC charging of a DC battery pack of an EV using field-oriented control (FOC).

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

Field-oriented control (FOC), also known as vector control, is an advanced method used to control the torque and speed of an electric motor, particularly in applications involving alternating current (AC) motors such as induction motors and permanent magnet synchronous motors (PMSMs). FOC is widely used in applications such as electric vehicles (EVs), robotics, and industrial automation due to its ability to provide smooth and efficient motor operation across a wide range of speeds and loads. FOC operates by decoupling the stator current into two orthogonal components: one that produces the magnetic field (flux) and another that generates torque. This decoupling allows for independent control of the electric motor's magnetic field and torque, akin to the control of a direct current (DC) motor, thereby enhancing performance, efficiency, and dynamic response. By transforming the three-phase motor currents into a two-axis coordinate system (a direct (d) axis and a quadrature (q) axis) aligned with the rotor's magnetic field, FOC enables precise and smooth control over the electric motor's operation, making it highly suitable for applications requiring high performance and precision, such as EVs, robotics, and industrial automation.

Conventionally, the battery pack of an EV is charged using a separate onboard charging module (OBCM). The OBCM is a critical component that facilitates the conversion of AC power from an external power source, such as a residential or public charging station, into direct current (DC) power required to charge the vehicle's battery. The OBCM is integrated within the vehicle and is designed to manage the charging process efficiently, ensuring optimal battery health and longevity. The OBCM typically includes dedicated power electronics, control systems, and safety mechanisms to regulate voltage and current, prevent overcharging, and protect against electrical faults. By enabling convenient and reliable charging, the OBCM plays a pivotal role in the overall functionality and user experience of electric vehicles. However, a conventional OBCM requires additional dedicated hardware (e.g., a power factor correction (PFC) circuit) that adds to the complexity and cost of an EV. Moreover, a conventional OBCM may have current regulation issues and/or suffer from distortions during zero crossings. Therefore, there is a need for improved methods and circuits for charging the battery pack of EVs.

In disclosed configurations, the AC electric motor(s) and the inverter of an EV are reused using FOC to convert grid-based AC power into DC power. The DC power may then be converted using a DC-to-DC converter into DC power suitable for charging a battery pack of the EV. By reusing the motor(s) and inverter using FOC, the additional dedicated hardware of a conventional OBCM can be eliminated, which reduces the complexity and cost of the EV. Moreover, using FOC for AC charging of a battery pack also leverages the FOC logic and modules already being used for controlling the AC electric motor for propelling the EV. Furthermore, using FOC for AC charging can ensure correct stator flux alignment with rotor position during AC charging to avoid undesirable motor rotation or torque.

While configurations are shown and described herein in connection with an electric vehicle (e.g., an automobile, a truck, an airplane, a train, a motorcycle, etc.), it should be understood that disclosed configurations may, additionally or alternatively, be used for AC charging of a DC battery pack of an electric vehicle using FOC for any other type of device (e.g., a drone, a robot, a bicycle, automated equipment, industrial equipment, etc.). Here, a vehicle or device may be operated by a person or may operate independently.

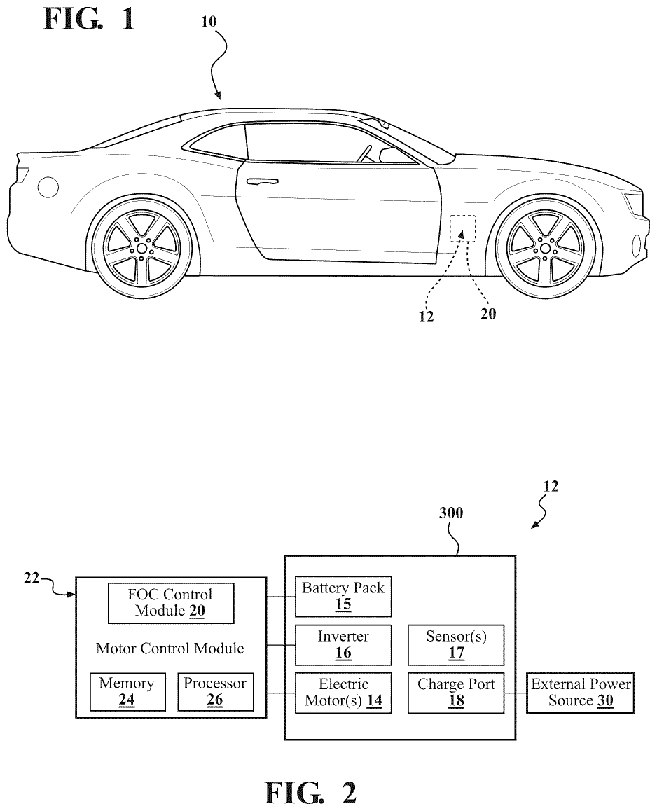

With particular reference to FIGS. 1, 2, and 3, an electric vehicle (EV) 10 (e.g., an automobile, a truck, an airplane, a train, a motorcycle, etc.) is shown in conjunction with a charging system 12. The vehicle 10 includes one or more AC electric motors 14 (also referred to herein as motors 14) that each include a respective rotor, a DC battery pack 15 configured to store and provide DC power, and an inverter 16 configured to convert DC power provided by the battery pack 15 into AC power for powering the motor(s) 14. An FOC control module 20 performs FOC for controlling the motor(s) 14, the inverter 16, and the battery pack 15 for powering the motor(s) 14 for propelling the vehicle 10. In particular, the FOC control module 20 decouples stator current into two orthogonal components: one that produces the magnetic field (flux) and another that generates torque. This decoupling allows for independent control of the electric motor's magnetic field and torque, akin to the control of a direct current (DC) motor, thereby enhancing performance, efficiency, and dynamic response. By transforming the three-phase motor currents into a two-axis coordinate system (a d-axis and a q-axis) aligned with the rotor's magnetic field, the FOC control module 20 enables precise and smooth control over the electric motor's operation. The FOC control module 20 utilizes one or more sensors 17 to measure the electric motor's phase currents, rotor position, and rotor speed, applies the necessary mathematical transformations and control algorithms to the sensed phase currents, rotor positions, and rotor speeds, and controls power electronics (e.g., the inverter 16) to drive the electric motor(s) 14 based on the computed control signals.

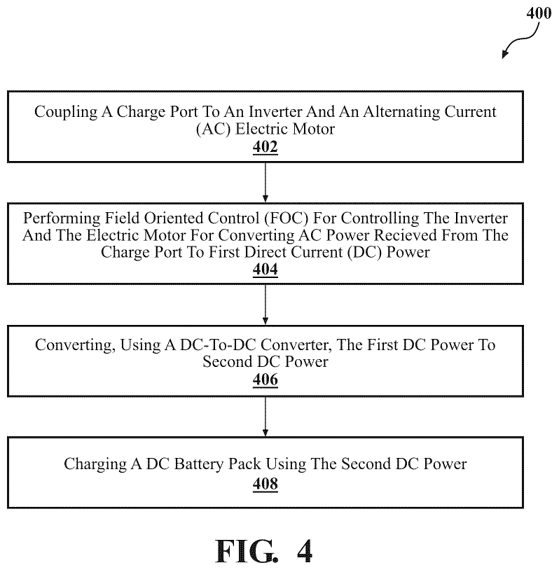

The battery pack 15 may include any number and/or type(s) of battery cells. The FOC control module 20 may be stored and executed by, for example, a motor control module (MCM) 22 of the vehicle 10. Specifically, the MCM 22 may store instructions for executing the operations shown in FIG. 4 or as described herein on, for example, memory hardware 24. The instructions may be executed by data processing hardware (e.g., a processor 26) of the MCM 22 to perform the operations.

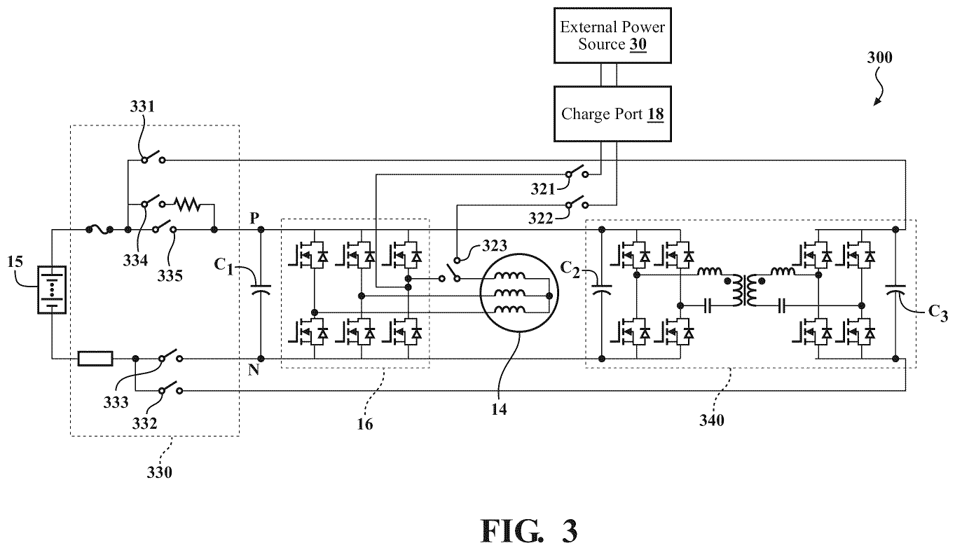

The charging system 12 may be used to perform AC charging of the DC battery pack 14 of the vehicle 10 using FOC. The charging system 12 includes a charge port 18 configured to receive AC power from an external AC power source 30, such as a residential or public charging station. To charge the battery pack 15, the MCM 22 selectively couples the charge port 18 to the inverter 16 and the electric motor(s) 14. As shown in FIG. 3, the MCM 22 selectively couples the charge port 18 to the inverter 16 and the electric motor(s) 14 by closing switches 321 and 322 and controlling a relay 323 to connect one phase of AC power (e.g., between 85 and 270 volts) received from the external power source 30 to one phase of the motor(s) 14. While FIG. 3 depicts one phase of the external power source 30 being connected to a particular phase of the motor(s) 14, the phase of the external power source 30 may be connected to a different phase of the motor(s) 14, or multiple phases of the external power source 30 may be connected to multiple phases of the motor(s) 14.

Thereafter, the FOC control module 20 performs FOC for controlling the inverter 16 and the electric motor 14 for converting AC power received from the external AC power source 30 into DC power at a capacitor C₂. The MCM 22 then charges the battery pack 14 using the DC power. In the illustrated example, the MCM 22 charges the battery pack 14 by closing switches 331 and 322 of a battery disconnect unit (BDU) 330. In some implementations, a DC-to-DC converter 340 (see FIG. 3) converts the DC power generated using the inverter 16 and the electric motor 14 into DC power at a capacitor C₃ that is used to charge the battery pack 14. In particular, the DC power generated using the inverter 16 and the electric motor 14 may have a different voltage from the DC power generated by the DC-to-DC converter 320.

In the illustrated example, the BDU 330 also includes switches 333 and 334 for pre-charging the inverter 16 and a capacitor C₁, and switches 333 and 335 for powering the inverter 16 for providing AC power to the electric motor(s) 14 for propelling the vehicle 10.

In some implementations, performing FOC for controlling the inverter 16 and the electric motor 14 for converting AC power received via the charge port 18 to DC power includes controlling a rotor reference frame to be substantially fixed, controlling a d-axis current command to be sinusoidal and, in some examples, controlling a q-axis current to be fixed (e.g., zero) to avoid torque generation. Additionally, or alternatively, performing FOC for controlling the inverter 16 and the electric motor 14 for converting AC power received via the charge port 18 to DC power includes performing a resonant controller to regulate current at a pre-determined frequency. Performing FOC for controlling the inverter 16 and the electric motor 14 for converting AC power received via the charge port 18 to DC power may also include performing a resonant controller to regulate current at a pre-determined frequency in addition to, in some examples, performing a conventional controller, such as a proportional-integral-derivative (PID) controller or a lead/lag compensator, for performing current control, wherein the current control may be performed within an inner loop with an outer loop controlling either power or voltage. Performing FOC for controlling the inverter 16 and the electric motor 14 for converting AC power received via the charge port 18 to DC power may also include performing a phase lock loop configured to provide a stable grid voltage measurement and using the stable grid voltage measurement as a reference for aligning grid current.

In some examples, the electric motor includes a permanent magnet motor, and the FOC control module 20 pre-aligns a motor position such that a d-axis of the rotor is aligned with a phase of the electric motor 14, for example, the phase to which the charge port is connected. In some implementations, performing FOC for controlling the inverter 16 and the electric motor 14 for converting AC power to the DC power includes aligning the electric motor 14 with an x-axis. Additionally, or alternatively, performing FOC for controlling the inverter 16 and the electric motor 14 for converting AC power received via the charge port 18 to DC power includes performing initial rotor alignment using a gear lash or a clutch. Additionally, or alternatively, performing FOC for controlling the inverter 16 and the electric motor 14 for converting AC power received via the charge port 18 to DC power includes adding small β-axis or q-axis current commands to generate a small magnetic torque to reposition the rotor when rotor movement occurs. Performing FOC for controlling the inverter 16 and the electric motor 14 for converting AC power received via the charge port 18 to DC power may also include using an average reluctance torque to reposition the rotor when rotor movement occurs by injecting a small amount of AC current on a β-axis or a q-axis.

In some implementations, performing FOC for controlling the inverter 16 and the electric motor 14 for converting AC power received via the charge port 18 to DC power includes performing a position controller including at least one of a PID controller, a PID controller in series with an integrator, or a lead/lag compensator. Additionally, or alternatively, performing FOC for controlling the inverter 16 and the electric motor 14 for converting AC power received via the charge port 18 to DC power includes performing current regulation using a rotating or stationary reference frame either using α-β signals or a-b-c signals.

In some examples, the FOC control module 20 reverses a direction of grid power flow between a grid-to-vehicle mode of operation and a vehicle-to-grid mode of operation. In some implementations, performing FOC for controlling the inverter 16 and the electric motor 14 for converting AC power received via the charge port 18 to DC power includes feeding forward of a grid voltage to regulate current. Additionally, or alternatively, performing FOC for controlling the inverter 16 and the electric motor 14 for converting AC power received via the charge port 18 to DC power includes performing field winding current regulation to turn off a rotor magnetic field or adjust a rotor magnetic field level to achieve at least one of a desired machine inductance level, machine saliency, or grid voltage synchronization, that allows mitigation of torque. In some implementations, performing FOC for controlling the inverter and the electric motor for converting the second AC power to the second DC power may also include performing a pulsating vector excitation (PVE) sensorless method that uses a voltage response on a q-axis of an estimated reference frame to allow aligning the d-axis of the estimated reference frame with the magnetic field d-axis of the rotor.

FIG. 4 is a flowchart of an example arrangement of operations for a method of AC charging of a battery pack of an electric vehicle using FOC. The operations may be performed by data processing hardware (e.g., the processor 26) based on executing instructions stored on memory (e.g., the memory hardware 24). Many other ways of implementing the method 400 may be employed. For example, the order of execution of the operations may be changed, and/or one or more of the operations and/or interactions may be changed, eliminated, sub-divided, or combined. Additionally, the operations of FIG. 4 may be carried out sequentially and/or in parallel by, for example, separate processing threads, processors, devices, discrete logic, circuits, etc.

At operation 402, the method 400 includes coupling the charge port 18 to the inverter 16 and the AC electric motor(s) 14. At operation 404, the method 400 includes performing FOC for controlling the inverter 16 and the electric motor(s) 14 for converting an AC power received from the charge port 18 to first DC power. At operation 406, the method 400 includes converting, using the DC-to-DC converter 330, the first DC power to second DC power. At operation 408, the method 400 includes charging the battery pack 15 using the second DC power.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
an alternating current (AC) electric motor having a rotor;
a battery pack configured to provide first direct current (DC) power;
an inverter configured to convert the first DC power provided by the battery pack to first AC power for powering the electric motor;
a charge port configured to receive second AC power from an external AC power source;
data processing hardware; and
memory hardware in communication with the data processing hardware, the memory hardware storing instructions that, when executed by the data processing hardware, cause the data processing hardware to perform operations comprising:
selectively coupling the charge port to the inverter and the electric motor;
performing field-oriented control (FOC) for controlling the inverter and the electric motor for converting the second AC power to second DC power; and
charging the battery pack using the second DC power.

2. The vehicle of claim 1, further comprising a DC-to-DC converter, wherein charging the battery pack using the second DC power comprises:
converting, using the DC-to-DC converter, the second DC power to third DC power; and
charging the battery pack using the third DC power.

3. The vehicle of claim 1, wherein performing FOC for controlling the inverter and the electric motor for converting the second AC power to the second DC power comprises:
controlling a reference frame to be substantially aligned with a rotor position;
controlling a d-axis current command to be sinusoidal; and
controlling a q-axis current to be fixed.

4. The vehicle of claim 1, wherein performing FOC for controlling the inverter and the electric motor for converting the second AC power to the second DC power comprises performing a resonant controller to regulate current at a pre-determined frequency.

5. The vehicle of claim 1, wherein performing FOC for controlling the inverter and the electric motor for converting the second AC power to the second DC power comprises performing current control in an inner loop with an outer loop performing voltage or power control.

6. The vehicle of claim 1, wherein performing FOC for controlling the inverter and the electric motor for converting the second AC power to the second DC power comprises:
performing a phase lock loop configured to provide a stable grid voltage measurement; and
using the stable grid voltage measurement as a reference for aligning grid current.

7. The vehicle of claim 1, wherein:
the electric motor comprises a permanent magnet motor; and
the operations further comprise pre-aligning a motor position such that a d-axis of the rotor is aligned at 0 or 180 degrees with a phase of the electric motor to which the charge port is connected.

8. The vehicle of claim 1, wherein performing FOC for controlling the inverter and the electric motor for converting the second AC power to the second DC power comprises performing a pulsating vector excitation (PVE) sensorless method that uses a voltage response on a q-axis of an estimated reference frame to allow aligning the d-axis of the estimated reference frame with the magnetic field d-axis of the rotor.

9. The vehicle of claim 1, wherein performing FOC for controlling the inverter and the electric motor for converting the second AC power to the second DC power comprises performing initial rotor alignment using a gear lash or a clutch.

10. The vehicle of claim 1, wherein performing FOC for controlling the inverter and the electric motor for converting the second AC power to the second DC power comprises adding small β-axis or q-axis current commands to generate a small average magnetic torque to reposition the rotor when rotor movement occurs.

11. The vehicle of claim 1, wherein performing FOC for controlling the inverter and the electric motor for converting the second AC power to the second DC power comprises using an average reluctance torque to reposition the rotor when rotor movement occurs by injecting a small amount of AC current on a β-axis or a q-axis.

12. The vehicle of claim 1, wherein performing FOC for controlling the inverter and the electric motor for converting the second AC power to the second DC power comprises performing a rotor position controller comprising at least one of a proportional-integral-derivative (PID) controller, a PID controller in series with an integrator, or a lead/lag compensator.

13. The vehicle of claim 1, wherein performing FOC for controlling the inverter and the electric motor for converting the second AC power to the second DC power comprises performing current regulation using a rotating or stationary reference frame either using a-b signals or a-b-c signals.

14. The vehicle of claim 1, wherein the operations further comprise reversing a direction of grid power flow between a grid-to-vehicle mode of operation and a vehicle-to-grid mode of operation.

15. The vehicle of claim 1, wherein performing FOC for controlling the inverter and the electric motor for converting the second AC power to the second DC power comprises feeding forward of a grid voltage to regulate current.

16. The vehicle of claim 1, wherein performing FOC for controlling the inverter and the electric motor for converting the second AC power to the second DC power comprises performing field winding current regulation to turn off a rotor magnetic field or adjust a rotor magnetic field level to achieve at least one of a desired machine inductance level, machine saliency, or grid voltage synchronization, that allows mitigation of torque.

17. A system comprising:
an alternating current (AC) electric motor having a rotor;
a battery pack configured to provide first direct current (DC) power;
an inverter configured to convert the first DC power from the battery pack to first AC power for driving the electric motor;
a charge port configured to receive second AC power from an AC power source;
data processing hardware; and
memory hardware in communication with the data processing hardware, the memory hardware storing instructions that, when executed by the data processing hardware, cause the data processing hardware to perform operations comprising:
selectively coupling the charge port to the inverter and the electric motor;
performing field-oriented control (FOC) for controlling the inverter and the electric motor for converting the second AC power to second DC power; and
charging the battery pack using the second DC power.

18. The system of claim 17, further comprising a DC-to-DC converter, wherein charging the battery pack using the second DC power comprises:
converting, using the DC-to-DC converter, the second DC power to third DC power; and
charging the battery pack using the third DC power.

19. A computer-implemented method executed by data processing hardware that causes the data processing hardware to perform operations comprising:
coupling a charge port to an inverter and an alternating current (AC) electric motor;
performing field-oriented control (FOC) for controlling the inverter and the electric motor for converting AC power received from the charge port to first direct current (DC) power; and
charging a DC battery pack using the first DC power.

20. The computer-implemented method of claim 19, wherein charging the battery pack using the first DC power comprises:
converting, using a DC-to-DC converter, the first DC power to second DC power; and
charging the battery pack using the second DC power.
